(19) United States
(12) Patent Application Publication
(10) Pub. No.: US 2007/0013675 A1
(43) Pub. Date: Jan. 18, 2007

(54) Electronic apparatus

(75) Inventors: Kenji Nitobe, Hamura-shi (JP); Shinichi Yoshida, Hachioji-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/471,164

(22) Filed: Jun. 19, 2006

(30) Foreign Application Priority Data
Jun. 24, 2005 (JP) 2005-185225

(51) Int. Cl. G09G 5/00

(52) U.S. Cl. 345/173; 345/179

(57) ABSTRACT

According to one embodiment, an electronic apparatus includes a stationary-type main-body casing, a display screen which is provided on the main-body casing, a touch panel which is provided on the display screen, and a support member which is disposed to face an inner surface of the main-body casing, the support member constituting a storage section, which stores a pen for touching the touch panel, between the support member itself and the inner surface of the main-body casing. A gap between an intermediate part of the pen, which is stored in the storage section, and the support member is greater than a gap between each of both end portions of the pen, which is stored in the storage section, and the support member.

### CROSS-REFERENCE TO RELATED APPLICATIONS

This application is based upon and claims the benefit of priority from Japanese Patent Application No. 2005-185225, filed Jun. 24, 2005, the entire contents of which are incorporated herein by reference.

### BACKGROUND

1. Field

One embodiment of the invention relates to a stationary-type electronic apparatus including a pen for touching a touch panel.

2. Description of the Related Art

There is known an electronic apparatus such as a telephone or a personal digital assistant, which has a touch panel on the surface of a liquid crystal screen. The touch panel is a sheet-shaped switch with a so-called touch screen function. The touch panel is configured such that information can be input to the electronic apparatus when the touch panel is touched by a distal end of the pen.

The electronic apparatus has a storage section in its body. When the pen is not used, the pen is stored in the storage section. Various types of storage sections have been proposed. For example, a type of the storage section has been disclosed, which is configured such that an engaging portion, which is provided on an attachment member (corresponding to the pen), is hooked in an attachment hole which is made in a side surface of the apparatus body, and thereby the attachment member is attached to the apparatus body (see, for instance, Jpn. Pat. Appln. KOKAI Publication No. 2003-133752). In addition, a portable information terminal apparatus has been disclosed, wherein a pen is stored in an elongated columnar storage section which corresponds to the shape of the pen (see, for instance, Jpn. Pat. Appln. KOKAI Publication No. 2001-142625).

The electronic apparatus disclosed in Jpn. Pat. Appln. KOKAI Publication No. 2003-133752, however, is configured such that the engaging portion of the attachment member is inserted in the attachment hole of the apparatus body. Thus, if attachment/detachment is repeated, the engaging portion would be damaged, and the attachment of the attachment member would be disabled.

In the electronic apparatus disclosed in Jpn. Pat. Appln. KOKAI Publication No. 2001-142625, since the gap between the inner wall of the storage section, which is provided in the apparatus body, and the pen is substantially uniform, the pen needs to be pulled out straight along the axis of the pen when the pen is to be taken out. Thus, the action of taking out the pen is very difficult. In particular, in the case of the stationary-type electronic apparatus, the space for pulling out the pen needs to be provided on the peripheral side of the apparatus body, and a large space is needed for installation of the electronic apparatus.

Besides, the apparatus body of the prior-art electronic apparatus does not have an area on which the pen is temporarily placed. Consequently, when the user wishes to temporarily put down the pen, the user is required to store the pen in the storage section each time, or to place the pen on a location other than the apparatus body, for example, on the desk. However, it is time-consuming for the user to insert the pen in the storage section each time, and the pen, if placed on the desk, may be lost.

According to the present invention, a pen for touching a touch panel can easily be stored or taken out, and an installation space for the electronic apparatus can be reduced.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a perspective view of a telephone according to a first embodiment of the present invention;

FIG. 2 is an exploded perspective view of a display device according to the embodiment;

FIG. 3 is a longitudinal cross-sectional view of a support plate according to the embodiment;

FIG. 4 is a transverse cross-sectional view of the support plate according to the embodiment;

FIG. 5 is a plan view showing an opening portion according to the embodiment;

FIG. 6 is a front view of a pen according to the embodiment;

FIG. 7 is a side view of the pen according to the embodiment;

FIG. 8 is a plan view showing the pen that is stored in a storage section according to the embodiment;

FIG. 9 is a schematic view showing the pen that is stored in the storage section according to the embodiment;

FIG. 10 is an enlarged view of a proximal end portion of the pen that is stored in the storage section according to the embodiment;

FIG. 11 is a perspective view showing the pen that is placed on a panel body according to the embodiment;

FIG. 12 is a schematic view showing the pen that is placed on the panel body according to the embodiment;

FIG. 13 is an enlarged view showing the proximal end portion of the pen that is placed on the panel body according to the embodiment;

FIG. 14 is a schematic view showing a locus of the pen that is stored in the storage section according to the embodiment, and a locus of the pen that is taken out of the storage section;

FIG. 15 is a cross-sectional view showing a pen that is stored in a storage section according to a second embodiment of the invention; and

FIG. 16 is a cross-sectional view showing the pen that is placed on a panel body according to the second embodiment.

### DETAILED DESCRIPTION

Various embodiments according to the invention will be described hereinafter with reference to the accompanying drawings. In general, according to one embodiment of the invention, an electronic apparatus includes a stationary-type main-body casing, a display screen which is provided on the main-body casing, a touch panel which is provided on the display screen, and a support member which is disposed to face an inner surface of the main-body casing. The support member constitutes a storage section, which stores a pen for touching the touch panel, between the support member itself and the inner surface of the main-body casing. The support member supports both end portions of the pen, which is stored in the storage section, and there is a gap between an intermediate part of the pen, which is stored in the storage section, and the support member.

First and second embodiments of the present invention will now be described with reference to the accompanying drawings. In the description below, a “front side” refers to a side where a user is present at the time of using a telephone, and a “rear side” refers to a side opposed to the user with the telephone being interposed. A “left side” and a “right side” refer to a left side and a right side, as viewed from the user.

### First Embodiment

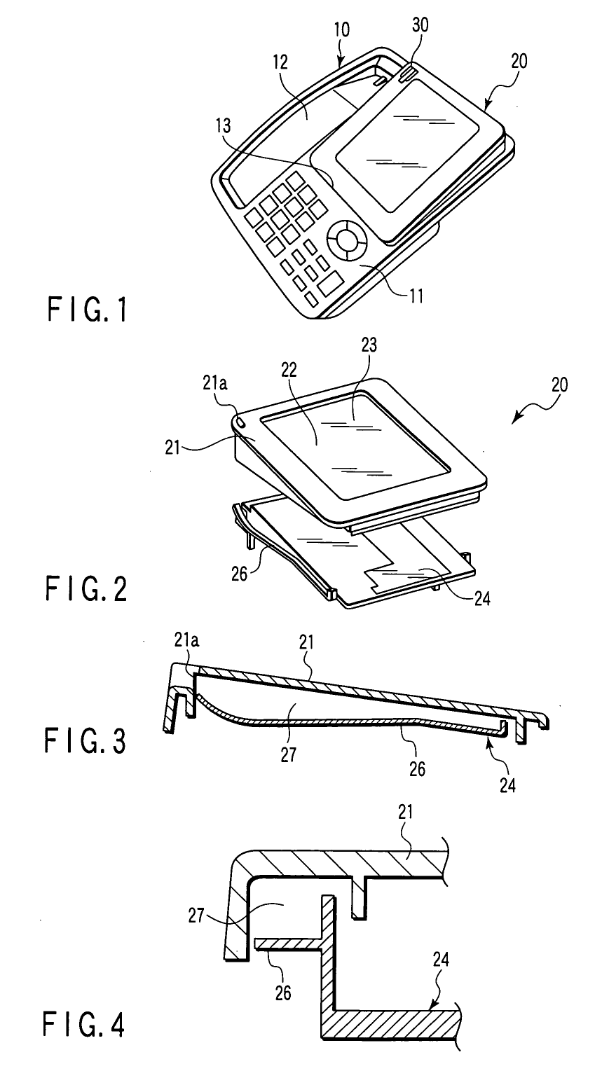

A first embodiment of the present invention is described with reference to FIG. 1 to FIG. 14.

FIG. 1 is a perspective view of a telephone according to the first embodiment of the present invention.

As shown in FIG. 1, the telephone is a so-called “stationary-type” telephone. The telephone comprises a telephone body 10, a display device 20 and a pen 30.

The telephone body 10 comprises a rectangular main-body casing 11, and a main-body board unit which is disposed within the main-body casing 11. The main-body casing 11 includes, on a left side part thereof, a telephone rest section 12 on which a phone receiver is placed. The main-body casing 11 includes, on a right side part thereof, a rectangular opening portion 13 in which the display device 20 is disposed. The main-body board unit includes electronic circuits, etc., which are necessary for the function of the telephone.

FIG. 2 is an exploded perspective view of the display device 20 according to the embodiment.

As is shown in FIG. 2, the display device 20 comprises a rectangular panel body 21 which is fitted in the opening portion 13 of the main-body casing 11, a liquid crystal display screen (display screen) 22 which is fitted in the panel body 21, a sheet-shaped touch panel 23 which is provided on the surface of the liquid crystal display screen 22, and a support member 24 which is provided on the back side of the liquid crystal display screen 22.

The panel body 21 is formed of, e.g. a resin plate. An opening portion 21a, in which the pen 30 is inserted, is formed at a rear left part of the panel body 21, that is, at a rear central part of the telephone body 10. The shape of the opening portion 21a will be described later.

The support body 24 supports the liquid crystal display screen 22 from the back side. The support body 24 includes an elongated support plate (support member) 26 for supporting the pen 30, which is provided at a position corresponding to the opening portion 21a in the lateral direction (width direction) of the telephone body 10, that is, at a central part of the telephone body 10.

FIG. 3 is a longitudinal cross-sectional view of the support plate 26 according to the embodiment, and FIG. 4 is a transverse cross-sectional view of the support plate 26 according to the embodiment.

As is shown in FIG. 3 and FIG. 4, the support plate 26 is disposed to face the inner surface of the panel body 26. A storage section 27 for storing the pen 30 is formed between the support plate 26 and the inner surface of the panel body 21. The support plate 26 extends in the longitudinal direction of the panel body 21. An intermediate part of the support plate 26 in its longitudinal direction is curved away from the panel body 21, and a distal end portion and a proximal end portion of the support plate 26 in its longitudinal direction are curved toward the inner surface of the panel body 21. The distance between the proximal end portion of the support plate 26 and the inner surface of the panel body 21 and the distance between the distal end portion of the support plate 26 and the inner surface of the panel body 21 are substantially equal to the diameter of a pen body 30a (to be described later) of the pen 30.

Thereby, in the state in which the pen 30 is stored in the storage section 27 that is defined by the panel body 21 and support plate 26, only the distal end portion and proximal end portion of the pen body 30a are supported by the support plate 26 and a large gap 28 is provided between the intermediate part of the pen body 30a and the support plate 26.

As will be described later, the pen 30 in the embodiment is inserted in the storage section 27 from the distal end portion thereof. Specifically, the proximal end portion of the pen 30 is positioned on the opening portion 21a side, and the distal end portion of the pen 30 is positioned on the side opposite to the opening portion 21a.

FIG. 5 is a plan view showing the opening portion 21a according to the embodiment.

As is shown in FIG. 5, the opening portion 21a comprises a recess portion 21b which is formed in the panel body 21, and a circular hole portion 21c which is formed in a front side wall of the recess portion 21b. The hole portion 21c is formed to have a slightly greater size than the diameter of the pen body 30a of the pen 30. The pen 30 is inserted in the panel body 21 through the hole portion 21c.

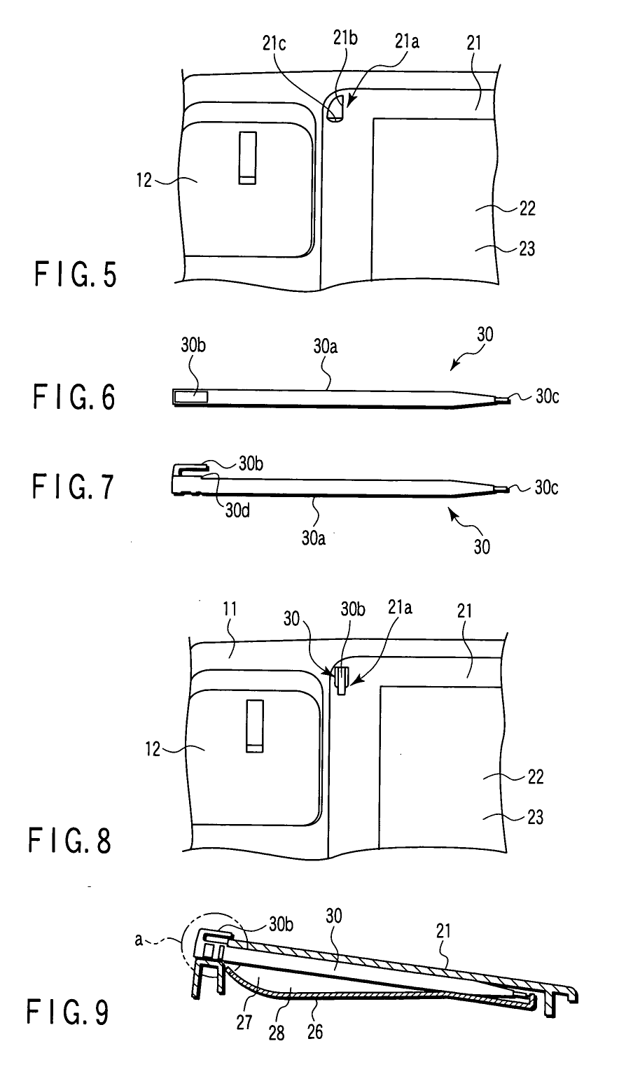

FIG. 6 is a front view of the pen 30 according to the embodiment, and FIG. 7 is a side view of the pen 30 according to the embodiment.

As is shown in FIG. 6 and FIG. 7, the pen 30 is used in order to touch the touch panel 23. The pen 30 comprises an elongated columnar pen body 30a, an elongated plate-shaped hook member 30b which is provided at the proximal end portion of the pen body 30a, a touch point 30c which is provided at the distal end portion of the pen body 30a, and an engaging wall 30d which is provided at the proximal end portion of the pen body 30a.

The hook member 30b extends in the longitudinal direction of the pen body 30a. A gap, which is slightly less than the thickness of the panel body 21, is provided between the outer peripheral surface of the pen body 30a and the hook member 30b. The hook member 30b is formed of, e.g. a resin material with a certain degree of resiliency.

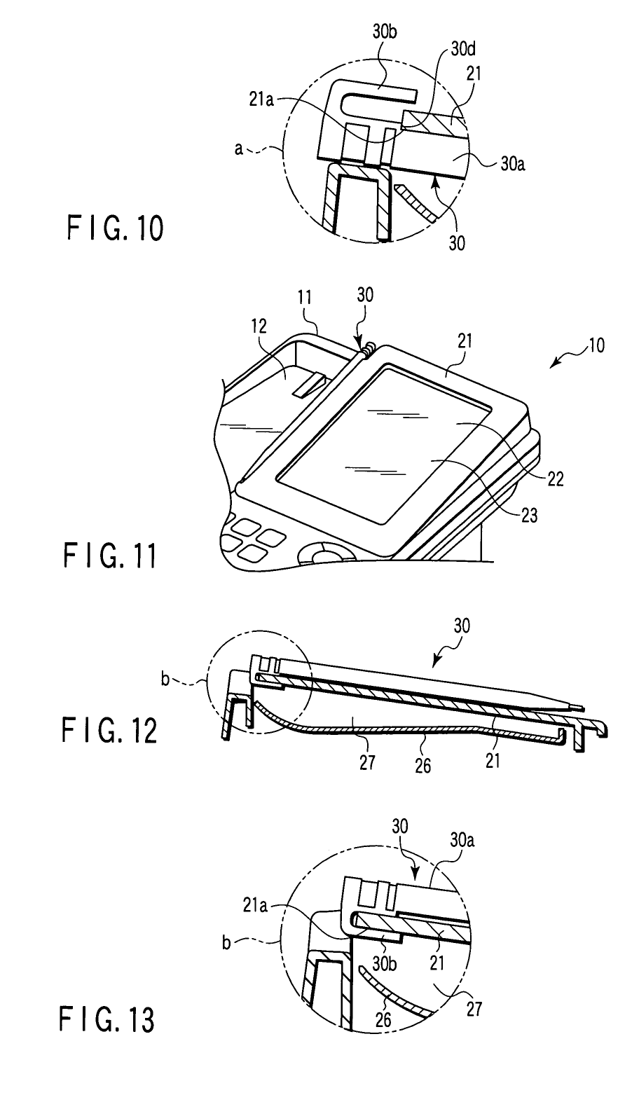

FIG. 8 is a plan view showing the pen 30 that is stored in the storage section 27 according to the embodiment, FIG. 9 is a schematic view showing the pen 30 stored in the storage section 27 according to the embodiment, and FIG. 10 is an enlarged view of the proximal end portion of the pen 30 stored in the storage section 27 according to the embodiment.

As is shown in FIG. 8 to FIG. 10, when the pen 30 is inserted in the storage section 27, an edge portion of the opening portion 21a of the panel body 21 is engaged with the engaging wall 30d of the pen 30. This prevents the pen 30 from entering the storage section 27 too deeply.

FIG. 11 is a perspective view showing the pen 30 that is placed on the panel body 21 according to the embodiment, FIG. 12 is a schematic view showing the pen 30 placed on the panel body 21 according to the embodiment, and FIG. 13 is an enlarged view showing the proximal end portion of the pen 30 placed on the panel body 21 according to the embodiment.

As is shown in FIG. 11 to FIG. 13, when the pen 30 is placed on the panel body 21, the edge portion of the opening portion 21a of the panel body 21 is clamped between the hook member 30b and the pen body 30a. Thereby, the pen 30 placed on the panel body 21 is not easily removed from the panel body 21.

Next, a method of storing the pen 30 and a method of taking out the pen 20 are described.

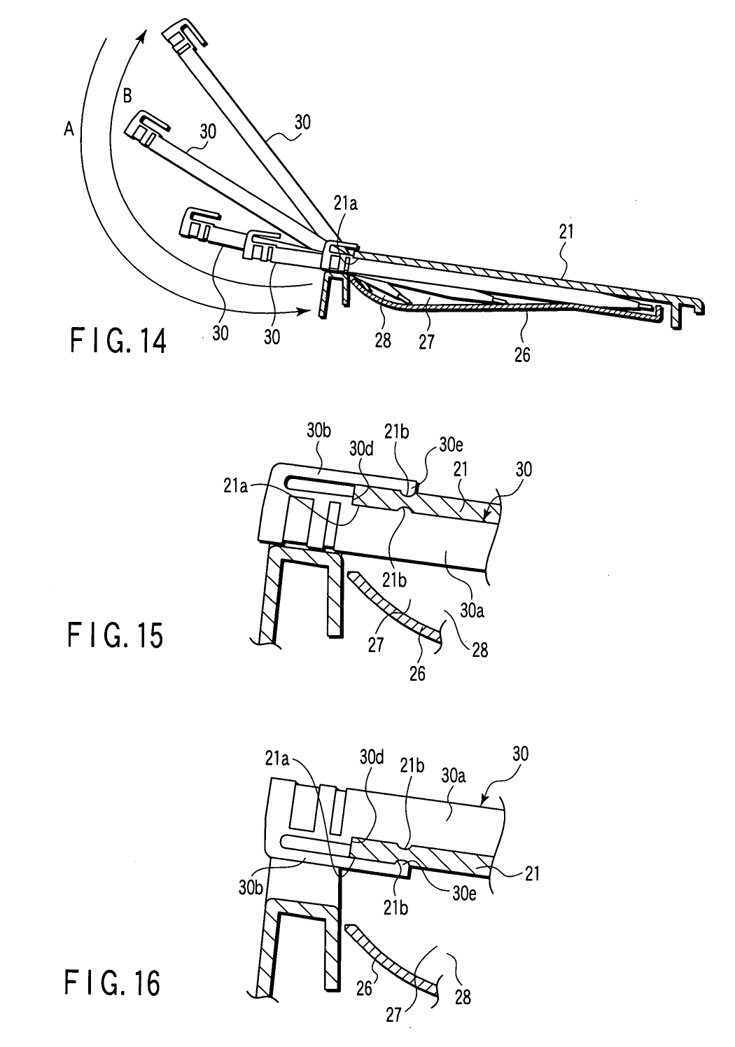

FIG. 14 is a schematic view showing a locus of the pen 30 that is stored in the storage section 27 according to the embodiment, and a locus of the pen 30 that is taken out of the storage section 27.

When the pen 30 is to be stored in the storage section 27, the user inserts the distal end portion of the pen 30 into the opening portion 21a and pushes the pen 30 along the axis thereof. The distal end portion of the pen 30 is guided by the support plate 26 toward a deeper region of the storage section 27, that is, toward the front side of the telephone body 10. Thus, the pen 30 advances into the storage section 27 while being rotated about the opening portion 21a. At last, the pen 30 is completely stored in the storage section 27. An arrow A in FIG. 14 indicates the locus of the proximal end portion of the pen 30 that is stored in the storage section 27.

When the pen 30 is to be drawn out of the storage section 27, the user holds the proximal end portion of the pen 20 and pulls it toward the rear side of the telephone body 10. Then, the panel body 21 is disengaged from between the pen body 30a and hook member 30b, and the proximal end portion of the pen 30 projects toward the rear side of the telephone body 10. When about ⅓ of the length of the pen 30 is drawn out of the storage section 27, the proximal end portion of the pen 30 is gradually raised. Thus, the pen 30 is drawn from the storage section 27 while being rotated about the opening portion 21a. At last, the pen 30 is completely drawn out of the storage section 27. An arrow B in FIG. 14 indicates the locus of the proximal end portion of the pen 30 that is taken out of the storage section 27.

When the pen 30 is to be stored or taken out, the pen 30 can be rotated about the opening portion 21a by virtue of the gap 28 that is provided between the intermediate part of the pen 30 stored in the storage section 27 and the support plate 26, thereby to permit movement of the distal end portion of the pen 30.

Next, the operational advantages, which can be obtained by the telephone according to the embodiment, are explained.

The support plate 26 in the present embodiment extends in the longitudinal direction of the panel body 21. The intermediate part of the support plate 26 in its longitudinal direction is curved away from the panel body 21, and the distal end portion and proximal end portion of the support plate 26 in its longitudinal direction are curved toward the inner surface of the panel body 21. Moreover, the distance between the proximal end portion of the support plate 26 and the inner surface of the panel body 21 and the distance between the distal end portion of the support plate 26 and the inner surface of the panel body 21 are substantially equal to the diameter of the pen body 30a of the pen 30.

Thereby, the large gap 28, which permits movement of the distal end portion of the pen 30, is provided between the pen 30 stored in the storage section 27 and the support plate 26. As a result, the degree of freedom of the distal end portion of the pen 30 is increased when the pen 30 is stored and taken out. In other words, the distal end portion of the pen 30 can be moved in a direction away from the panel body 21. Therefore, compared to conventional telephones, the pen 30 can be stored and taken out more easily.

Furthermore, when the pen 30 is stored or taken out, there is no need to project the pen 30 to the rear side of the telephone body 10 by a distance corresponding to the length of the pen 30. Hence, even in the case of the stationary-type telephone, as in the present embodiment, there is no need to provide a large space on the rear side of the telephone in order to draw out the pen 30. Therefore, compared to the prior art, the space which is necessary for installation of the telephone can be reduced.

In the present embodiment, the storage section 27 is provided at a substantially central part of the telephone body 10 in its lateral direction. Thus, whether the user is right-handed or left-handed, the pen 30 can smoothly be stored and taken out.

In this embodiment, the storage section 27 is provided in the panel body 21. Alternatively, the storage section 27 may be provided, for example, in the main-body casing 11.

In the embodiment, the pen 30 is hooked at the edge portion of the opening portion 21a of the panel body 21. Alternatively, the pen 30 may be hooked, for example, at a portion to be clamped, which is provided on the main-body casing 11 or panel body 21.

In the present embodiment, the invention is applied to the telephone. However, the invention is not limited to this embodiment. This invention can advantageously be applied to various types of stationary-type electronic apparatuses.

### Second Embodiment

A second embodiment of the present invention will now be described with reference to FIG. 15 and FIG. 16. A description of the structure and function of the second embodiment, which are common to those of the first embodiment, is omitted here.

FIG. 15 is a cross-sectional view showing a pen 30 that is stored in a storage section 27 according to the second embodiment of the invention, and FIG. 16 is a cross-sectional view showing the pen 30 that is placed on a panel body 21 according to the second embodiment.

As is shown in FIG. 15 and FIG. 16, a hook member 30b in this embodiment is longer than the hook member 30b in the first embodiment, and a projection 30e is formed on the hook member 30b at a position facing the pen body 30a. The projection 30e has a hemispherical shape. The projection 30e is disposed at a position that is away from the engaging wall 30d of the pen body 30a toward the distal end of the pen body 30a by a predetermined distance.

In addition, in this embodiment, the panel body 21 includes two recesses 21b at a position that is away from the edge of the opening portion 21a toward the front end of the telephone body 10 by the above-mentioned predetermined distance. The two recesses 21b are provided on the upper surface and lower surface of the panel body 21, respectively. The size of each recess 21b is substantially equal to the size of the projection 30e provided on the hook member 30b.

Thus, when the pen 30 is stored in the storage section 27 or the pen 30 is placed on the panel body 21, the projection 30e of the pen 30 is fitted in the recess 21b of the panel body 21 and the pen 30 is not easily disengaged from the panel body 21. In particular, when the pen 30 is placed on the panel body 21, the hand or finger often touches the pen 30. In this situation, the pen 30 tends to be easily disengaged from the panel body 21. However, if the projection 30e is fitted in the recess 21b in this fashion, the pen 30 is not easily disengaged or removed. As a result, the pen 30 is prevented from being lost.

The present invention is not limited to the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications ad would fall within the scope and spirit of the inventions.

What is claimed is:

1. An electronic apparatus comprising:
a stationary-type main-body casing;
a display screen which is provided on the main-body casing;
a touch panel which is provided on the display screen; and
a support member which is disposed to face an inner surface of the main-body casing, the support member constituting a storage section, which stores a pen for touching the touch panel, between the support member itself and the inner surface of the main-body casing, the support member supporting both end portions of the pen which is stored in the storage section, and there being a gap between an intermediate part of the pen, which is stored in the storage section, and the support member.

2. The electronic apparatus according to claim 1, further comprising:
a pen which is stored in the storage section, wherein the pen includes:
a pen body which is stored in the storage section; and
a hook which is provided at one end portion of the pen body and clamps a part of the main-body casing between the hook itself and an outer peripheral surface of the pen body.

3. The electronic apparatus according to claim 1, wherein the storage section is disposed at a central part in a width direction of the main-body casing.

4. The electronic apparatus according to claim 1, wherein the gap gradually increases toward a surface of installation of the main-body casing, as a position of the gap becomes closer to an intermediate part of the gap.
